(19) United States
(12) Patent Application Publication
(10) Pub. No.: US 2010/0257037 A1
(43) Pub. Date: Oct. 7, 2010

(54) Method and system for targeted incentives

(76) Inventors: William R. Matz, Atlanta, GA (US); Scott R. Swix, Duluth, GA (US)

Correspondence Address: AT&T Legal Department - SZ;Attn: Patent Docketing, Room 2A-207, One AT&T Way, Bedminster, NJ, 07921, US

(21) Appl. No.: 10/017,111

(22) Filed: Dec. 14, 2001

(51) Int. Cl. G06Q 30/00; G06Q 50/00; G06Q 10/00; H04H 60/32; G06F 15/16

(52) U.S. Cl. 705/14.12; 705/14.25; 705/14.13; 725/14; 709/206

(57) ABSTRACT

A method and system for targeting incentives. Incentives are selectively sent to user terminals based on a user classification. According to an embodiment of the present invention, a system defines matches between a user classification and an incentive. User data is collected from a plurality of sources. A system according to the present invention classifies a user and sends the incentive to the user if a match has been defined between the user classification and the incentive.

### CROSS REFERENCE TO RELATED APPLICATIONS

This application is related to co-pending application Ser. Nos. (Attorney docket #36968/265390 (BS1371), filed herewith), entitled, “Method and System to Perform Content Targeting,” (Attorney Docket No. 36968/265386 (BS01341), filed herewith), entitled “System and Method for Utilizing Television Viewing Patterns,” (Attorney Docket No. 36968/265389 (BS01378), filed herewith), entitled “System and Method for Developing Tailored Television Content Related Packages,” (Attorney Docket No. 36968/265387 (BS01342), filed herewith), entitled “System and Method for Identifying Desirable Subscribers,” (Attorney Docket No. 36968/265393 (BS01377), filed herewith), entitled “Advertising and Content Management Systems and Methods,” (Attorney docket #BS-00-138, filed May 22, 2001), entitled “Method and Apparatus for Providing Incentives to Viewers to Watch Commercial Advertisements,” and U.S. application Ser. No. 09/496,825, filed Feb. 1, 2000, which are hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### FIELD OF THE INVENTION

The invention relates to a system and method for targeting and sending incentives to a user for purchasing product.

### BACKGROUND

Brand recognition achieved through advertisements is important to many businesses. As a result, consumers are often overwhelmed by the volume of advertisements seen on television, in magazines, on the global computer network (commonly referred to as the “Internet”) and other media venues.

Capturing the attention of consumers amid the clutter of other advertisements is of great importance to businesses seeking to promote a brand. Easily remembered slogans have been used in television, radio, and magazine advertisements for many years. Many memorable commercials have gained recognition in popular culture for their lasting impressions on consumers.

In order for an advertisement to be valuable, however, it is not enough that consumers recognize the brand. A successful advertisement should increase actual sales of the product. If a product's market comprises only a small number of consumers, an advertisement is of very little value if it is not viewed by the relatively small group of consumers who purchase the product. For example, an advertisement for denture adhesive is only valuable if it is viewed by consumers who wear dentures or purchase denture adhesive for family members. In addition, advertisement space is used very inefficiently if an advertisement for a product used by a small set of consumers is viewed by a large number of consumers. Although showing the advertisement to a large group of consumer may reach the smaller group who may actually purchase the product, the advertisement time is wasted on the consumers who are unlikely to purchase the product.

One form of advertising for encouraging viewers of advertisements to purchase products is to send the consumer an incentive. An incentive is a purchasing term that gives an incentive to the consumer to buy a particular brand. Incentives include discount coupons or codes that are redeemable for a reduced purchase price or other attractive purchasing term. For example, a coupon might entitle a consumer to receive a free product or service in exchange for purchasing the specified product.

Incentives sent through the mail are expensive because of mailing and paper costs. Incentives sent by electronic mail are often ineffective because consumers are overwhelmed with electronic mail and may even find such incentives to be an annoyance, particularly if the consumer is not interested in the product. Incentives may also be attached to a consumer product. Such incentives only reach the consumers who purchase the product and are ineffective for reaching new consumers.

One method for reaching consumers who are likely to purchase a product while minimizing the wasted exposure to consumers who are unlikely to purchase a product is to place an advertisement in a media that the targeted customers are likely to be viewing. Information regarding consumer groups is collected and analyzed using numerous methods. This information is then used to predict consumer habits in a targeted group. For example, a company selling denture adhesive could determine that the majority of its customers are over age sixty-five. An advertising consultant might advise such a company that consumers over age sixty-five are likely to watch television shows including professional golf. Based on this information, the company selling denture adhesive concentrates its advertisements during professional golf tournaments. Decisions regarding when and where to place an advertisement may be even less scientific. For example, numerous commercials for automobiles and automobile accessories typically are placed during stock car races because advertisers assume that stock car race enthusiasts also enjoy purchasing and modifying automobiles. Similarly, advertisements for children's toys are placed in children's television shows.

This method of targeted advertising does not work well for incentives. Incentives are typically sent through the mail, through electronic mail, or attached to a product. Information about an incentives may be transmitted through a video broadcast, but video broadcasts are normally not in a form that is convenient to a consumer. Consumers generally prefer forms such as paper coupons or electronic coupons because there is no need to copy information about the incentive. Coupons may be taken directly to a store to be redeemed. In addition, although placing advertisements in a particular television show targets consumers who are likely to watch the show, such targeting is not a precise approach. The viewers of any particular show may not be a homogeneous group. For example, certainly not all viewers of professional golf tournaments wear dentures. Even in a well-understood demographic audience, many of the viewers of the show will be unlikely to purchase the product.

In addition, recent technological advances have diminished the value of advertisements shown in the middle of a television show. With the wide availability of video cassette recorders (“VCRs”) and digital video records (“DVRs”), viewers record television shows and may “fast-forward” the tape through the commercials. Television remote controls also allow viewers to watch other channels during commercials and then return to the television show. Information regarding incentives sent by broadcasts are even less effective when consumers may avoid seeing the advertisement.

Efforts have also been made to target advertisements to consumers on the Internet. Various mechanisms are used to record the viewing habits of a user at a particular user terminal. The content of the pages viewed is analyzed to determine what topics are of interest to a user. Advertisement are placed on the pages viewed by the user based on these particular topics of interest. These advertisements are often placed around the primary text or image in a web page and are commonly referred to as “banner ads.”

Although the Internet environment enables advertisements targeted specifically for an individual user, rather than a general demographic expected in viewers of a specific television show, targeted advertisements in the Internet environment have proven to be ineffective for capturing a viewers attention. Viewers are typically interested in the information on the web page and ignore the banner advertisements.

Advertisements on television are generally effective for capturing a viewer's attention. However, such advertisements do not convey incentives in a form that is convenient to a consumer such as a coupon and are typically displayed to a disproportionately large number of viewers who are unlikely to purchase the product. Targeted incentives on the Internet have the advantage of being displayed to consumers who have demonstrated some interest in the relevant product. However, advertisements displayed on the Internet have proven relatively ineffective in capturing the attention of an audience. A consumer using the Internet easily ignores Internet advertisements.

These and other problems are avoided and numerous advantages are provided by the methods and systems of the present invention.

### SUMMARY OF THE INVENTION

The present invention comprises methods and systems for targeting incentives. In one embodiment, the method involves defining a match between a user classification and an incentive. A system collects user data about a user associated with a user terminal, including user viewing selections. The user data includes data from a plurality of sources. The system then classifies the user in a user classification for characterizing the user and the user's behavior and transmits an incentive to the user if a match is defined between the user classification and the incentive. For example, a match could be defined between users characterized by a classification indicating that they watch sports programs and an incentive for purchasing a sports related product.

In another embodiment, the user data further includes sales data of the user. Examples of sales data include information regarding credit card purchases, online purchases, and purchases of other retail products. Sales data may include the prices paid for products and the time that the purchase was made by the user. A system detects the relationship between the sales data and the user viewing selections. The user is classified in a user classification if a relationship is detected between the user sales data and user viewing selections. In one embodiment, a relationship between the sales data and user viewing selections is detected if the user views advertisements for a product and then purchases the product. In another embodiment, the user data includes whether the product associated with the incentive was purchased.

In still another embodiment, the user data includes whether the product associated with the incentive was purchased.

In yet another embodiment, the user is classified in a user classification if the user data satisfies a predefined parameter.

In various embodiments, the user data includes global computer network viewing data, survey data, or sales data. In other embodiments, the incentive includes an image embedded into media content, a video program or a banner.

Systems and methods according to the present invention provide the advantage of integrating information about a user from multiple sources. Relationships between these sources are detected by the system and may be used to send targeted incentives to a user. For example, a relationship between the sales data of a user and the viewing selections of a user may be detected by a system, and the user classified based on the relationship. Therefore, a system can detect if a user purchases products for which advertisements have been viewed or for which incentives have been sent. Incentives that are targeted for a specific viewing audience have the advantage that they are more cost efficient than incentives sent to a large, untargeted consumer group.

These and other advantages will become apparent to those of ordinary skill in the art with reference to the detailed description and drawings.

### BRIEF DESCRIPTION OF THE DRAWINGS

FIG. 1 is a block diagram of an exemplary network for transmitting media content to users.

FIG. 2 is a block diagram of an exemplary network for collecting data from a plurality of sources.

FIG. 3 is a block diagram of user data according to the present invention.

FIG. 4 shows an embodiment of a method according to the present invention.

FIG. 5 shows another alternative embodiment of a method according to the present invention.

FIG. 6 shows a block diagram of an embodiment according to the present invention.

FIG. 7 shows yet another alternative embodiment of a method according to the present invention.

### DETAILED DESCRIPTION

According to the present invention, incentives are selectively sent to user terminals based on a user classification. According to an embodiment of the present invention, a system defines matches between user classifications and an incentive. Data is collected from a plurality of sources which may be cross referenced to determine relationships, for example, between user actions and viewing selections. A system classifies a user and an incentive, and transmits the incentive to the user if a match has been defined between the user classification and the incentive.

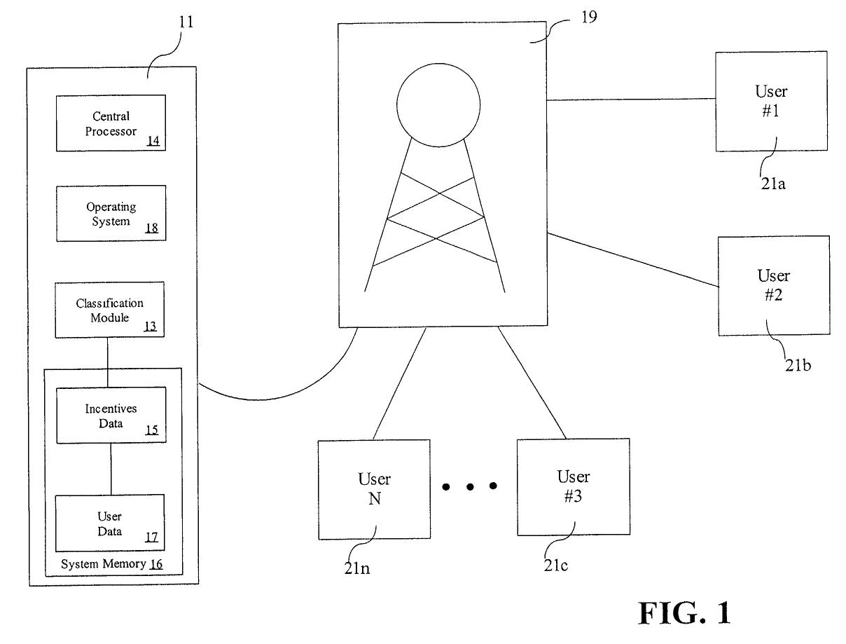

FIG. 1 is a block diagram of an exemplary network for transmitting media content to users. The media content is transmitted from a broadcast station 19 to users at user terminals 21a-21n. The broadcast station 19 may be a television airwave broadcast station or a cable broadcast station or other device for broadcasting media content in a media delivery network. In the embodiment shown in FIG. 1, the broadcast station 19 comprises a cable television broadcast station. The media content is generally in the form of video content, but may also include text, video games, and audio content. The media content includes advertisements, which may be in the form of video, a superimposed image, or an advertisement framing other content commonly referred to as a “banner.” Banner advertisement may be used, for example, to appear at the same time as an electronic program guide. The advertisements may include incentives such as electronic coupons. The media content may be transmitted by cable connections, satellite broadcast, or air wave broadcasts to user terminals 21a-21n.

Users at user terminals 21a-21n select broadcast media content from the user terminals 21a-21n. User terminals 21a-21n may include any network media device for receiving media content, including video display terminals, set-top boxes (often called set-top terminals, cable converters or home communications terminals), televisions, radios or personal computers connectable to the Internet or other media devices for communicating with a media delivery network. In the example shown, user terminals 21a-21n are television sets having a set-top box. User terminals 21a-21n include a user interface for receiving user viewing commands. User terminals 21a-21n send the user viewing selections to the broadcast terminal 19, for example, using the methods and systems disclosed in (Attorney Docket No. 36968/265386 (BS01341), filed herewith), entitled “System and Method for Utilizing Television Viewing Patterns,” (Attorney Docket No. 36968/265389 (BS01378), filed herewith), entitled “System and Method for Developing Tailored Television Content Related Packages,” (Attorney Docket No. 36968/265387 (BS01342), filed herewith), entitled “System and Method for Identifying Desirable Subscribers.”

The broadcast terminal 19 is in communication with a server 11. In the example shown, the broadcast terminal 19 is in communication with the server 11 through a conventional cable television delivery network. The server 11 includes a central processor 14 for controlling and processing various computer functions, an operating system 18 for running software applications, and system memory 16 for storing information. The server 11 also includes a classification module 13 for classifying users and sending instructions to the broadcast station 19. The server 11 also includes incentive data 15 and user data 17 stored in the system memory 16.

When a user makes a viewing selection at a user terminal 21a-21n, the viewing selections are transmitted to the broadcast station 19 and the server 11. Examples of viewing selections include when a user is watching media content and what media content the user is watching including the channels watched, the programs viewed from the channels watched, and the time that the channel is watched. Viewing selections include how much of a particular television show or advertisement the user watches. User data 17 is a database containing information about a user. The user data 17 is organized using conventional database management techniques. User data 17 includes user viewing selections collected by the user terminals 21a-21n, and other information, as will become apparent from the following discussion. The incentive data 15 includes information about incentives, such as identifying information. For example, incentives may be identified by the product, the demographic audience to which the incentive is aimed, and other information about the incentive. The incentive data 15 may be uploaded into the system memory 16 by a system in communication with the server 11 or entered into the system memory 16 through the server 11 by a computer operator. The incentives may be broadcast from the broadcast terminal 19. As would be understood by one of ordinary skill in the art, alternative network arrangement may be implemented. For example, the user terminals 21a-21n may be connected to the server 11 directly rather than forming an indirect connection through the broadcast station 19. In addition, incentives may be transmitted by other conventional methods and systems. For example, incentives may be sent by mail, printed on postcards, or sent by an electronic message to a computer or user terminals 21a-21n.

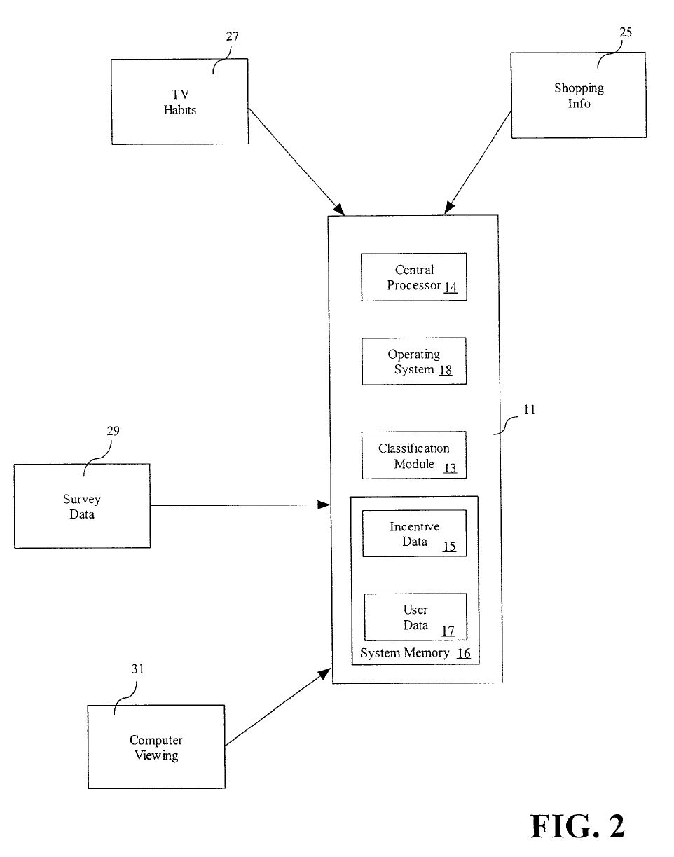

FIG. 2 is a block diagram of an exemplary network for collecting data from a plurality of data sources. A data source is any source of information and may include a database and/or a data collection device. Examples of data sources include records of retail purchases such as credit card purchases and online purchases, records of user viewing selections, and records of user information such as demographic information. In addition to the configuration shown in FIG. 1, the server 11 may be connected to a plurality of data sources as depicted in FIG. 2. Each data source contributes data to the user data 17 in the system memory 16. The classification module 13 reads and analyzes the user data 17. Examples of data sources include shopping information 25, television habits 27, survey data 29, and computer viewing information 31. Various configurations may be used to efficiently store and process the user data 17. For example, information about a user may be collected by a device and stored in a temporary memory location, such as a buffer, and uploaded to the user data 17 periodically. In another example, multiple servers or a network of computers may perform the function of the server 11.

Shopping information 25 includes information about the user's shopping habits. Shopping habits may be monitored through credit card purchase records or online electronic purchase records. Retail stores may keep records of purchases by using customer shopping cards in which customers are given discounts in exchange for using a shopping card. The shopping card is scanned every time a customer makes a purchase. Therefore, the customer and the customer's purchases are identified and recorded into a database regardless of whether the customer uses a credit card or debit card for the purchase. In addition, if an incentive has been sent to a user, the shopping information 25 may include information indicating whether the user has used the incentive to purchase an item.

Television habits 27 include information about the user's viewing habits. In one embodiment, a set top box may record television viewing habits using methods and systems described in (Attorney Docket No. 36968/265386 (BS01341), filed herewith), entitled “System and Method for Utilizing Television Viewing Patterns,” (Attorney Docket No. 36968/265389 (BS01378), filed herewith), entitled “System and Method for Developing Tailored Television Content Related Packages,” (Attorney Docket No. 36968/265387 (BS01342), filed herewith), entitled “System and Method for Identifying Desirable Subscribers,” including shows and advertisements viewed. The television habits 27 may include information about how much of a television show or advertisement was viewed, for example, whether a user viewed an entire advertisement or only the first five seconds of the advertisement. In another embodiment, the user manually keeps track of television shows that the user watches and records the television shows in a log.

Survey data 29 includes information collected by surveys about a user. Survey data 29 is collected by surveys, such as online surveys, telephone surveys, or mail-in surveys, and may include personal information about a user such as names, geographic locations, income levels and other demographic information.

Computer viewing information 31 includes information collected about what a user views on a computer. Examples of computer viewing information 31 include web pages viewed by the user on the Internet, Internet shopping purchases, topics of Internet searches, video games played, and other computer activities.

Information is collected from data sources such as shopping information 25, television habits 27, survey data 29 and computer viewing information 31 to the system memory 16 and stored as user data 17. In addition, the classification module 13 analyzes the collected information and stores the analysis in the user data 17.

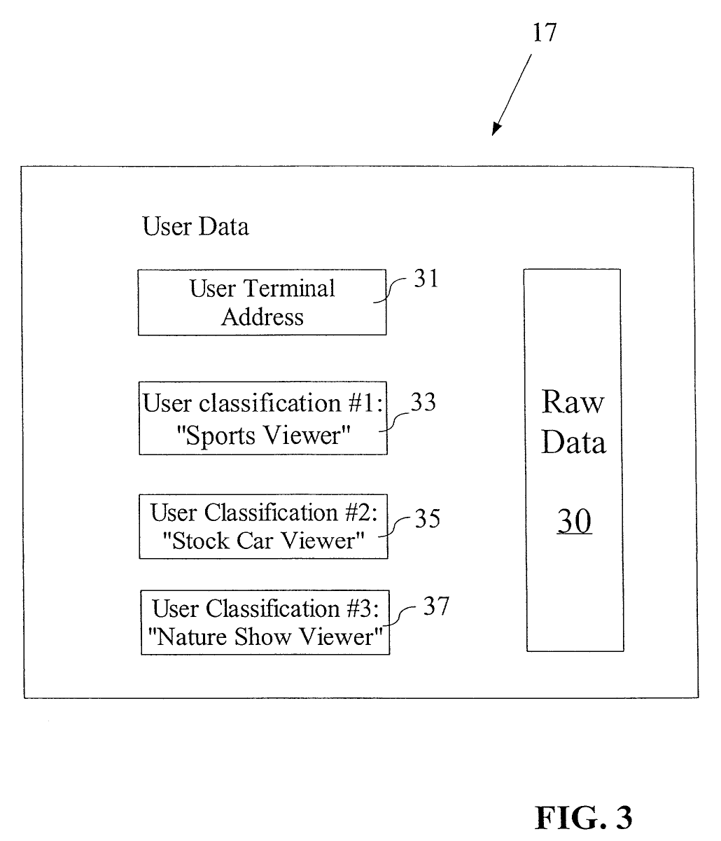

FIG. 3 is a block diagram of user data according to the present invention. In the example depicted in FIG. 3, analyzed classifications of user data 17 are shown. User data 17 includes information about one or more users such as user 32, for example, in one or more data fields. The user data 17 includes raw data 30 about the user collected from the various data sources, such as the data sources depicted in FIG. 2. Referring back to FIG. 3, user 32 includes a user terminal address 31. The user terminal address 31 is an address for identifying the hardware of a user terminal such as the user terminals 21a-21n as depicted in FIG. 1.

In the example depicted in FIG. 3, user 32 is classified into three classifications: a first user classification 33 entitled “sports viewer,” a second user classification 35 entitled “stock car viewer,” and a third user classification 37 entitled “stock car viewer—model car buyer.” The process by which the classification module 13 (FIG. 2) picks a classification is described in greater detail below. Each user classification is associated with a set of parameters for determining whether a particular user should be classified in the user classification. For example, the first user classification 33 entitled “sports viewer” may be defined as any user who watches more than an average of three hours of sports programming per week, the second user classification 35 entitled “stock car viewer” may be defined as any user who watches more than an average of two stock car races per month, and the third user classification 37 entitled stock car viewer—model car buyer” may be defined as a user who watches more than an average of one stock car race per month and has purchased a model car within the last year.

In the example shown, the first user classification 33 entitled “sports viewer” and the second user classification 35 entitled “stock car viewer” are defined by parameters based on the television habits 27 of the user as shown in FIG. 2. The third user classification 37 entitled “stock car viewer—model car buyer” is defined by parameters based on the shopping information 25 and the television habits 27 of the user as shown in FIG. 2. Any number of user classifications may be defined based on data and information depicted in FIG. 2 such as shopping information 25, television habits 27, survey data 29, computer viewing data 31 or any combination thereof.

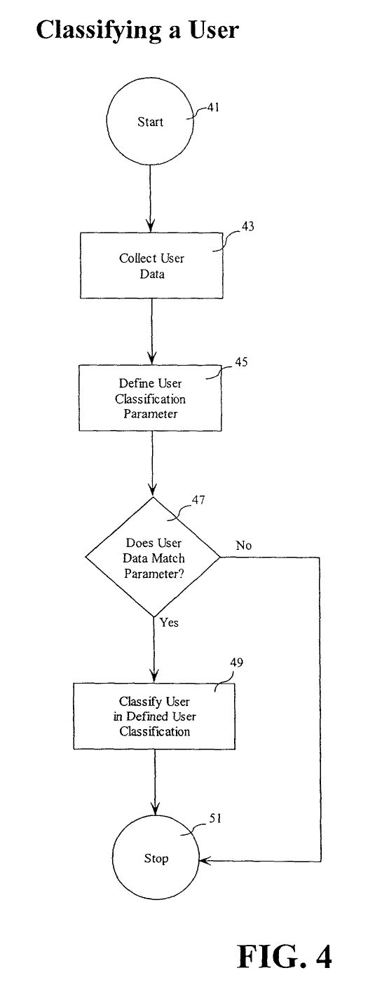

FIG. 4 shows an embodiment of a method according to the present invention. More specifically, FIG. 4 shows a method for classifying a user that may be performed by the server 11 and various components thereof (FIG. 2). The method starts at step 41. The server collects user data at step 43, for example, from data sources, such as the data sources depicted in FIG. 2 at step 43. Data from the data sources is transferred to a database such as user data 17 in FIG. 2. The user data 17 is organized using conventional database management techniques. Referring back to FIG. 4, at step 45 the classification module 13 (FIG. 2) includes a definition of a user classification parameter. User classification parameters are defined characteristics that are used to classify a user. An example of a user classification and corresponding classification parameter is a sports fan with a classification parameter that requires a predefined level of sports viewing. For example, if the classification parameter for a sports fan is three hours of sports viewing per week, then a user will be classified as a sports fan only if the user views at least three hours of sports per week. The user classification parameter may be a defined term in the classification module or defined by accepting input from an operator as a variable into the classification module.

The classification module 13 compares the user data and the parameters at step 47. If the user data matches the parameter at step 47, the user is classified in the defined user classification at step 49. The classification module 13 records the classification as user data 17. If the user data does not match the user parameter at step 47, then the classification module 13 stops at step 51. The process depicted in FIG. 4 may be repeated for many classifications and many users. The classification module 13 may classify a user into a plurality of classifications using the process depicted in FIG. 4. The various classifications are recorded as user data 17. For example, each user has a data field in the user data 17 database for storing information about the user, including the relevant user classifications. The user classifications are used to determine which incentives should be sent to the user.

### Example 1

In one illustrative example of the application of classification module 13, the user views a stock car race every Saturday and Sunday afternoon, and the classification module analyzes the user data to determine if the user should be classified as a “sports viewer.” In the example, the user classification parameter for a sports viewer is a requirement that the user view at least three hours of sports shows on average per week.

The classification module first examines whether the user is a sports viewer beginning at step 41 in FIG. 4. The user data is collected at step 43, which includes information that the user views a stock car race every Saturday and Sunday afternoons. The races average three and a half hours each. The classification module determines that the user data, specifically, watching two three and a half hour races a week, matches the user classification parameter requirement that the user view at least three hours of sports shows on average per week at step 47. Therefore, the user is classified as a sports viewer by the classification module 13 at step 49 and the classification module stops at step 51.

The classification module 13 then adds the classification “sports viewer to the user data in a configuration such as the user data 17 depicted in FIG. 3, which includes a first user classification 33 of “sports viewer.” This information is valuable to an advertiser because the user may be targeted for specific incentives of particular interest to sports fans. Similarly, additional user classifications may be added to further refine the information, such as a user classification for “stock car viewer.”

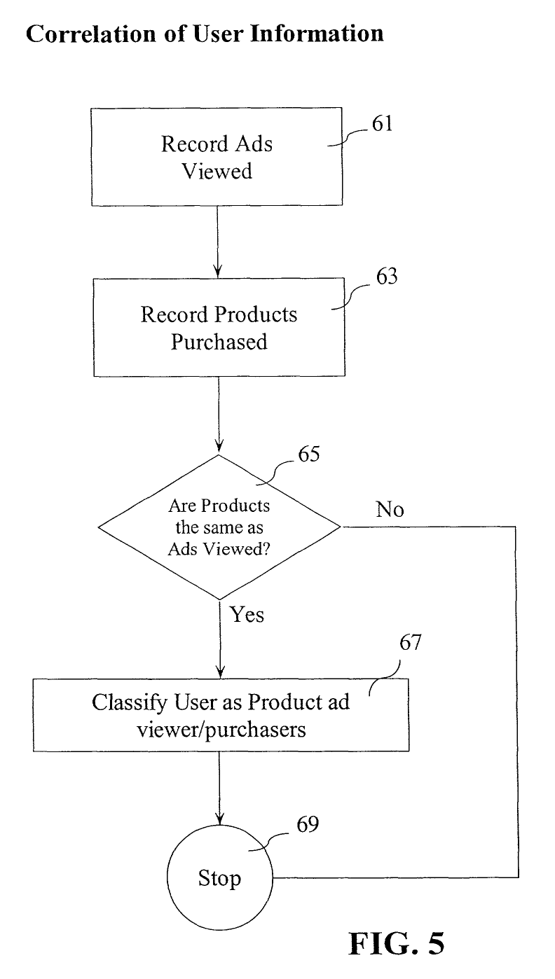

FIG. 5 shows another alternative embodiment of a method according to the present invention for correlating user data 17 from a plurality of sources to classify a user. The user data 17 as shown in FIG. 2 includes information about the advertisements that a particular user viewed from the television habits 27 and products purchased from the shopping information 25. Referring back to FIG. 5, the server 11 (FIG. 2) records advertisements viewed at step 61 and products purchased at step 63. At step 65, the classification module compares the products purchased and the advertisements viewed. For examples, the advertisement is for a specific product, and if the product purchased is the same as the product featured in the advertisement at step 65, then there is a match between the products purchased and the advertisements viewed. The classification module 13 classifies the user as an advertisement viewer/purchaser for the particular product at step 67 and stops at step 69.

### Example 2

In an illustrative example for correlating user data 17 from a plurality of sources to classify a user, referring to FIG. 2, the user data 17 collects television habits 27 through the server 11 which indicate that the user has viewed ten advertisements for Brand A soft drinks and twenty advertisements for Brand B soft drinks in one month. The user data 17 collects shopping information 25 from the user's grocery store shopping records indicating that the user buys two liters of Brand B soft drinks twice a month.

Referring back to FIG. 5, the server records advertisements viewed, specifically, ten advertisements for Brand A and twenty advertisements for Brand B at step 61. The server collects products purchased, specifically, two liters of Brand B soft drinks twice a month, at step 63. At step 65, the classification module examines whether the products purchased are the same as the advertisements viewed. Because the user views advertisements for Brand B and buys Brand B, the user is classified as a Brand B advertisement viewer/purchaser at step 67. The user is not classified with respect to Brand A because the user does not buy Brand A. The classification module stops at step 69.

The classification of a user as an advertisement viewer/purchaser is valuable to purchasers and sellers of advertisement. The user may be targeted for specific incentives based on the classification and the user's subsequent purchasing habits could be monitored. For example, based on Example 2, Brand A could decide to deliver an incentive to the user and monitor the user's shopping information to determine if the user switches brands. On the other hand, if a user watches many advertisements for a product and never purchases the product, the user may not be receptive of the advertisements. Based on this information, people who market the product may decide to stop sending advertisements or incentives to a user who never purchases the product despite viewing advertisements because such advertising does not appear to influence the user. Products purchased and advertisements viewed may be included as a user classification parameter, for example, in the method depicted in FIG. 4. A predefined level of advertisements watched or products purchased may be required for a user to be classified. For example, the user classification parameter may be a requirement that the user view a defined number of advertisements and purchase a defined amount of the product.

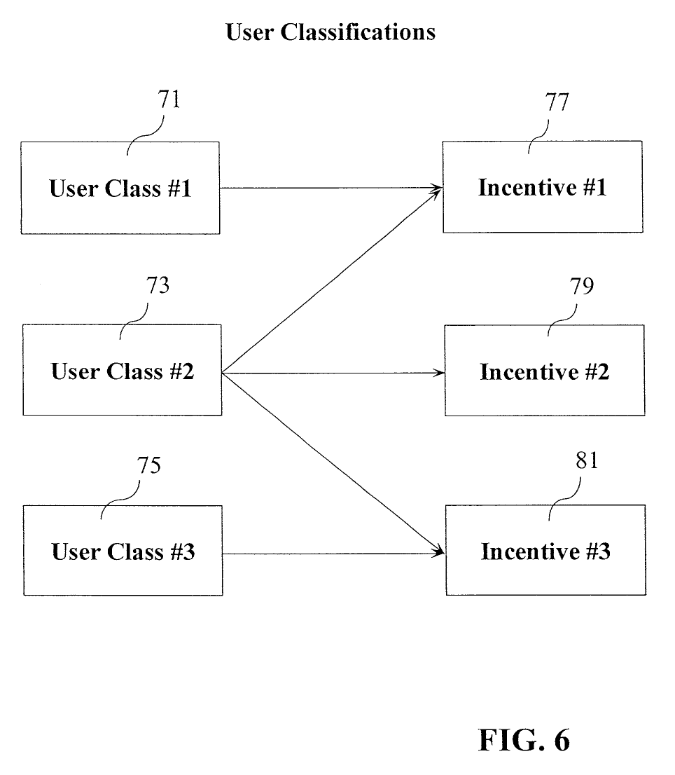

FIG. 6 shows a block diagram of an embodiment according to the present invention for matching a user classification with a particular incentive, referred to herein as “matching definitions.” The matching definitions are located in the system memory 16 on the server 11 shown in FIG. 2 and are used by the classification module to send instructions for sending incentive, for example, to the broadcast station 19. In the example shown in FIG. 6, a first user classification 71 is matched to a first incentive 77. A second user classification 73 is matched to a first incentive 77, a second incentive 79, and a third incentive 81. A third user classification 75 is matched to a third incentive 81. The matches are used to define which incentives are transmitted to which viewers. Therefore, all users, such as the user 17 depicted in FIG. 3, having a first user classification 71 are sent the first incentive 77. All users having the second user classification 73 are sent the first incentive 77, the second incentive 79, and the third incentive 81. All users having the third classification 75 are sent the third incentive 81.

### Example 3

In an illustrative example of an embodiment of the advertisement matches depicted in FIG. 6, the first incentive 77 is a coupon for a stock car die cast model, the second incentive 79 is for a reduced price to purchase sports tickets, and the third incentive 81 is for a discount for football memorabilia purchased over the internet. The first user classification 71 is called a stock car racing fan, for example having a user parameter requiring that the user watch an average of one race per week. The first user classification 71 is matched to the first incentive 77 for a stock car die cast model because a stock car die cast model is probably of interest to a stock car race fan. The second user classification 73 is called an ultra sports fan, for example, having a user parameter requiring that the user watch at least three different sports programs every week. The second user classification 73 is matched to the first incentive 77 for a stock car die cast model, the second incentive 79 for the ticket purchases, and the third incentive for football memorabilia because the second user classification 73 has a general interest in sports and all three incentive are probably of interest. The third user classification 75 is called a football fan, for example, having a user parameter requiring that the user watch an average of two football games per month. The third user classification 75 is matched to the third incentive 81 for football memorabilia, which is probably of interest to a football fan. Any number of classifications and incentive matches may be made. For example, the second incentive 79 for ticket discounts, may be of interest to the first, second, and third user classifications, 71, 73, and 75, and therefore, the matching definitions may be changed to map the first, second, and third user classifications, 71, 73, and 75 to the second incentive 79.

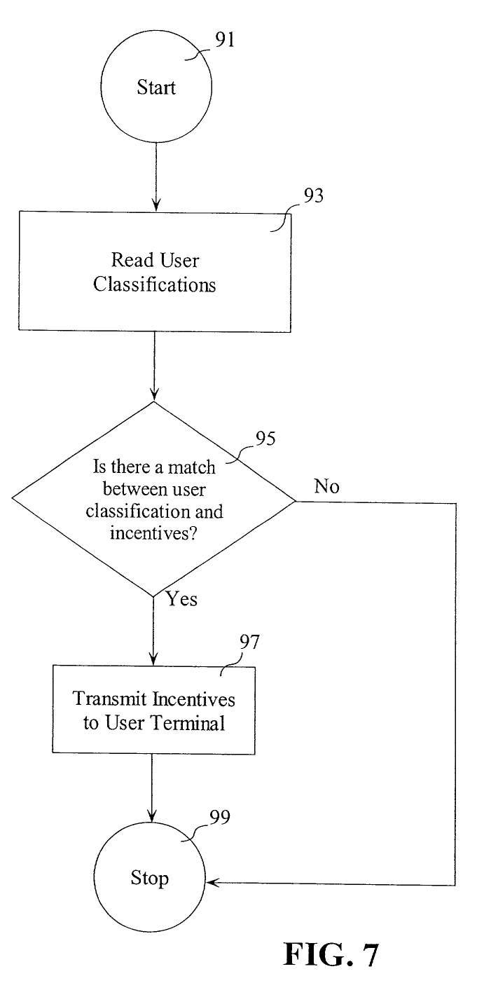

FIG. 7 shows another embodiment of a method according to the present invention. The classification module 13 as depicted in FIG. 1 sends transmission instructions to the broadcast station 19. As discussed above, the server 11 includes user data 17 and incentive data 15. The incentive data 15 includes information identifying one or more specific incentive. The classification module 13 includes matching definitions, such as the matching definitions depicted in FIG. 6. User classifications are matched to one or more incentives. In one embodiment, the user to which the broadcast is sent is identified by the address of the user terminal, such as one of the user terminals 21a-21n. The user terminal address 31 is depicted in FIG. 3 and is a component of the user data 17. In another embodiment, a user at one of the user terminals 21a-21n in FIG. 1 may be prompted at the user terminal 21a-21n to input a user identification, such as a code or password. Therefore, the system identifies the user by a code such that multiple users at the same user terminal may be distinguished.

Referring again to FIG. 7, the classification module begins at step 91. The classification module 13 reads the user classifications assigned to a particular user terminal stored as user data 17 at step 93, such as user classifications 33, 35 and 37 as depicted in FIG. 3. The classification module 13 determines whether there is a match defined between the user classifications and a particular incentive at step 95 using matching definitions such as the matching definitions depicted in FIG. 6. If there are no matches defined between a user classification assigned to a particular user and incentives, the classification module 13 stops at step 99. If there is a defined match, the classification module 13 sends instructions to the broadcast terminal to transmit the incentive to the user at step 97. In an alternative embodiment, the classification module sends instructions to alternative delivery systems, such as a mailing system or electronic mailing system, to transmit the incentive to the user.

In the embodiment shown in FIG. 1, the broadcast station 19 transmits the advertisements to the user terminal 21a-21n by overriding default advertisements. The broadcast from the broadcast station 19 typically includes default advertisements. The instructions to transmit the incentive to the user may include instructions to override default advertisements in the broadcast media with incentives for which a match has been determined. If a user classification is matched to more than one incentive, the matched incentives are transmitted to the user at different times and more than one default advertisement may be overridden.

Alternative methods for transmitting incentives to the user include electronic mail and conventional mail.

### Example 4

In one illustrative example for transmitting incentives to a user, a first user and a second user use the same user terminal, specifically user terminals 21a in FIG. 1, for viewing television. The first and second users are assigned separate identification codes, which are recorded in the system memory 16 for identifying the user. The identification codes may be assigned by a central administrator and communicated to the first and second users by electronic or mail messages, or the first and second users may choose an identification code and enter it to the user terminal 21a. The user terminal 21a sends the code to the system memory 16. The first user views a stock car race every Saturday and Sunday afternoon, and the classification module analyzes the user data as described in Example 1 to determine that the first user is classified as a “sports viewer.” In the example, the user classification parameter for a sports viewer is a requirement that the user view at least three hours of sports shows on average per week. The second user watches nothing but cooking shows and has not been assigned a user classification.

An advertiser for a tennis shoe orders an incentive to be sent to all “sports viewers” matching the defined classification. The incentive is that the tennis shoes will cost 50% of the normal retail price if the consumer presents the coupon at purchase. In this example, the coupon is transmitted to the user electronically and printed by the user at the user terminal. An operator adds the information about the incentive to the incentive data 15 in FIG. 1, including information identifying the incentive. The operator also adds a match between the user classification “sports viewer” and the tennis shoe incentive. The media content that comprises the incentive is transmitted to the broadcast station 19.

The first user turns on user terminal 21a to watch the Saturday stock car race. The user terminal 21a prompts the first user for a user identification code. Once the first user's identification code is received, the user terminal 21a transmits the identification code to the broadcast station 19 and the server 11. The user terminal 21a also transmits the identification number of the user terminal 21a to the broadcast station 19 and the server 11. The user data collected, such as user data 17 as depicted in FIG. 3, is therefore identified as associated with the first user.

The classification module 11 in FIG. 1 has previously determined that the first user is classified as a “sports viewer” through a process such as the process described in Example 1. The “sports viewer” classification is stored as a first user classification 33 in the user data 17 as depicted in FIG. 3.

Referring to FIG. 7, the classification module begins at step 91. The classification module reads the user classifications assigned to the first user at user terminal 21a at step 93. Specifically, the classification module reads the “sports viewer” user classification. The classification module determines whether there is a match defined between the user classifications and a particular incentive at step 95. Because a match has been defined between the tennis shoe incentive and the “sports viewer” user classification, at step 97 the classification module sends instructions to the broadcast terminal to transmit the incentive to the user at step 97.

Referring back to FIG. 1, the broadcast terminal 19 receives the instructions from the classification module 13 to transmit the tennis shoe incentive to the user. The broadcast station 19 replaces a default advertisement in the broadcast programming with the tennis shoe incentive.

If the second user identification were entered into the user terminal 21a, the classification module 13 would not detect a match between the user classifications and the incentive at step 95 in FIG. 7. The classification module would stop at step 99, and no instructions to replace default advertisements in the broadcast programming would be sent.

It will be apparent to those with skill in the art that there are many alterations that may be made in the embodiments of the invention described above without departing from the spirit and scope of the invention. For example, there are many ways that circuits and electronic elements may be combined to implement the method and system described herein in various systems and hardware environments. The present invention may be implemented in various network environments, including wireless and computer networks, or other networks supporting electronic devices and the transmission of media content in television, radio, Internet or other network environments. There are similarly many ways that independent programmers might provide software to provide the functionality associated with the present invention as taught herein without departing from the spirit and scope of the invention. Having thus generally described the invention, the same will become better understood from the following claims in which it is set forth in a non-limiting manner.

1. A method, comprising:
defining a match between a user classification and an incentive;
receiving content information describing content selections from a user;
receiving clickstream data describing actions performed by the user while viewing the content selections;
receiving credit card purchase records associated with the user;
merging, by a processor, the clickstream data with the content information to generate event timeline data that describes the clickstream data and the content information over time;
comparing the event timeline data to the credit card purchase records; and
classifying the user in the user classification when the event timeline data matches the credit card purchase records; and
transmitting the incentive to the at least one user.

2. The method of claim 1, wherein the user's content selections comprise a channel viewed by the user, a program shown on the channel, and the amount of time the channel is watched.

3. The method of claim 1, further comprising collecting the content information.

4. The method of claim 1, wherein the user's content selections comprise how much of an advertisement the user views.

5. (canceled)

6. The method of claim 1, wherein classifying the user further comprises relating the credit card purchase records and the user's content selections when the user views advertisements for a product and purchases the product.

7. The method of claim 1, wherein classifying the user further comprises classifying the user in the user classification when the clickstream data satisfies a predefined parameter defining television viewing habits for the user classification.

8. The method of claim 1, further comprising determining whether a product associated with the incentive was purchased.

9. The method of claim 1, wherein the clickstream data comprises global computer network viewing data.

10. The method of claim 1, further comprising retrieving survey data.

11. The method of claim 1, wherein receiving the user's credit card purchase records comprises receiving a price paid for a product and a time the product was purchased.

12. The method of claim 1, wherein the incentive comprises an image embedded into television media content.

13. The method of claim 1, wherein the incentive comprises a redeemable electronic coupon.

14. The method of claim 1, wherein the incentive comprises a banner.

15. A system for delivering targeted incentives to a user, comprising:
a processor executing code stored in memory that causes the processor to:
receive a user's content selections associated with a set-top box;
receive clickstream data describing actions performed by the user while viewing the content selections;
comparing the clickstream data to a table stored in the memory, the table defining events of interest;
when the clickstream data matches an entry in the table, then generate event timeline data that describes an event of interest and the content information over time;
receive credit card purchase records describing purchases by the user;
define a match between a user classification and an incentive;
compare the event timeline data to the credit card purchase records; and
classify the user in the user classification when the event timeline data matches to the credit card purchase records.

16. (canceled)

17. (canceled)

18. The system of claim 15, wherein the code further causes the processor to relate the user's credit card purchase records and the user's content selections when the user views advertisements for a product and purchases the product.

19. The system of claim 15, wherein the code further causes the processor to classify the user in the user classification if the event of interest satisfies a predefined parameter, the parameter defining television viewing habits for the user classification.

20. The system of claim 15, wherein the code further causes the processor to determine whether a product associated with the incentive was purchased.

21. The system of claim 15, wherein the code further causes the processor to receive global computer network viewing data.

22. The system of claim 15, wherein the code further causes the processor to receive survey data.

23. The system of claim 15, wherein the code further causes the processor to determine a price paid for a product and a time the product was purchased.

24. The system of claim 15, wherein the incentive comprises an image embedded into television media content.

25. The system of claim 15, wherein the incentive comprises a video program.

26. The system of claim 15, wherein the incentive comprises a banner.

27. The system of claim 15, wherein the incentive comprises a coupon.

28. The method of claim 1, wherein the incentive comprises a video program.

29. The method of claim 1, wherein the user's content selections comprise video games.

30. The method of claim 1, wherein the user's content selections comprise audio content.

31. The method of claim 1, further comprising identifying the incentive by a product.

32. The method of claim 1, further comprising identifying the incentive by a demographic.

33. The method of claim 1, wherein transmitting the incentive to the user comprises transmitting the incentive by mail.

34. The method of claim 1, wherein transmitting the incentive to the user comprises transmitting the incentive by electronic message.

35. The method of claim 1, further comprising receiving records related to a shopping card in which the user is given a discount in exchange for using the shopping card.

36. The method of claim 1, further comprising receiving separate identification codes identifying each user of a common user terminal.

37. The system of claim 15, wherein the code further causes the processor to receive separate identification codes identifying each user of a common user terminal.

38. A method for marketing, comprising:
defining a match between a user classification and a redeemable electronic coupon;
receiving content information associated with a content selection associated with a user;
receiving clickstream data describing actions performed by the user while viewing the content selection;
comparing the clickstream data to a table stored in the memory, the table defining events of interest;
receiving the credit card purchase records describing purchases associated with the user;
when the clickstream data matches an entry in the table, then collecting an event of interest;
merging, by a processor, the event of interest with the content information to generate event timeline data that describes the event of interest and the content information over time;
comparing the event timeline data to the credit card purchase records;
classifying the user by the processor in a user classification when the event timeline data matches the credit card purchase records; and
transmitting the redeemable electronic coupon to the user.
